(19) United States
(12) Patent Application Publication
(10) Pub. No.: US 2008/0131244 A1
(43) Pub. Date: Jun. 5, 2008

(54) SYSTEM, METHOD AND MACHINE FOR CONTINUOUS LOADING OF A PRODUCT

(75) Inventor: R. C. Murray, Lakewood Ranch, FL (US)

Correspondence Address: GIFFORD, KRASS, SPRINKLE,ANDERSON & CITKOWSKI, P.C, PO BOX 7021, TROY, MI, 48007-7021, US

(73) Assignee: Pouch Pac Innovations, LLC, Sarasota, FL (US)

(21) Appl. No.: 11/947,173

(22) Filed: Nov. 29, 2007

Related U.S. Application Data
(60) Provisional application No. 60/867,657, filed on Nov. 29, 2006.

(51) Int. Cl. B65G 67/00

(52) U.S. Cl. 414/373; 414/809; 901/2

(57) ABSTRACT

An apparatus, machine and method for continuous unloading and loading of an object includes an unloading station with in-feed device, frame and transport device disposed thereon that moves an object between a unload end and a load end of the in-feed device. A robotic transfer means is positioned at the unload end of the in-feed device. The robotic transfer device includes a base portion, an arm attached to the base portion and a gripping member located on a distal end of the arm. An object storage device is positioned adjacent the unload end of the in-feed device for holding a plurality of objects arranged in a predetermined manner. The robotic transfer device operatively unloads the object from the storage device and places the object on the unload end of the transport device, which transport the object to the load end of the in-feed device for loading onto another device.

### CROSS REFERENCE TO RELATED APPLICATION

This application claims priority of U.S. Provisional Patent Application Ser. No. 60/867,657 filed Nov. 29, 2006, which is incorporated herein by reference.

### BACKGROUND OF THE INVENTION

1. Field of the Invention

The present invention relates generally to a system for transferring an object with respect to a machine, and more particularly to a system, method, and machine for continuous unloading and loading of an object with respect to a machine using a robotic transfer device.

2. Description of the Related Art

Automated manufacturing processes incorporating a high speed machine typically involve the transfer of an object to, from or between machines. For example, an object is transferred from one machine to another machine, or between lines in a machine. The object may be a disposable, portable container for storing a product. An example of such a container is a flexible pouch or a tray. The pouch or tray can be pre-formed on one machine, and transferred to another machine for filling and sealing. The object may be any type of a product that is sealed within a container. The product can be prepared on one machine, and transferred to another machine for placement into and sealing within the container.

Various styles of machines can be utilized in the manufacturing process, and a machine may accommodate one or more manufacturing lines. The manufacturing line can allow for various sequential stations, with a particular operation or operations taking place at each station of the manufacturing line. Through the use of automated machinery, the sequential operations can occur at a relatively high rate. One transfer technique for placing an object on an automated machine for processing utilizes a human operator to unload the object onto the machine or load the object into a carrier or another machine. Another transfer technique utilizes a transfer device, such as a robot, an electromechanical device, or the like to perform the unload and load operations. However, a coordinated input/output of objects with respect to the machine may be necessary to achieve a high production rate. A feature of such coordination may include the accurate and consistent positioning of the object as it is fed onto the machine, without a variation in distance therebetween.

While these present techniques work, the overall speed and accuracy of the automated machine may be compromised, due to the necessary coordination between the in-feed line, manufacturing stations and other associated manufacturing lines or machines. Thus, there is a need for a smart loading system that consistently and accurately unloads and loads an object associated with an automated machine.

### SUMMARY OF THE INVENTION

Accordingly, a system, method and machine for continuous unloading and loading of an object is provided. The system includes an unloading station with in-feed device, frame and transport device disposed thereon that moves an object between an unload end and a load end of the in-feed device. A robotic transfer device is positioned at the unload end of the in-feed device. The robotic transfer device includes a base portion, an arm attached to the base portion and a gripping member located on a distal end of the arm. An object storage device is positioned adjacent the unload end of the in-feed device for holding a plurality of objects arranged in a predetermined manner. The robotic transfer device operatively unloads the object from the storage device and places the object on the unload end of the transport device, which transports the object to the load end of the in-feed device for loading onto another apparatus.

A method for continuous unloading and loading of an object onto a machine includes the steps of providing an unloading station having an in-feed device that includes a frame and a transport device disposed on the frame that moves the object between a unload end of the in-feed device and a load end of the in-feed device. A robotic transfer means is positioned at the unload end of the in-feed device. The robotic transfer device includes a base portion, an arm attached to the base portion and a gripping member located on a distal end of the arm. An object storage device or object holder is positioned adjacent the unload end of the in-feed device for holding a plurality of object arranged in a predetermined manner. The robotic transfer device unloads the object from the storage device or object holder and places the object on the unload end of the transport device. The object is transported to the load end of the in-feed device for loading onto another apparatus.

One advantage of the present invention is that an improved system, method and machine for unloading and loading an object to and from a manufacturing line is provided. Another advantage of the present invention is that a system, method and machine for unloading and loading an object is provided that utilizes a robotic transfer device to accurately and reliably place the object on the manufacturing line, or remove the object from the manufacturing line. Still another advantage of the present invention is that a system, method and machine is provided that is adaptable to use with various styles of objects, such as products, or containers or the like. A further advantage of the present invention is that a system, method and machine for unloading and loading an object to and from the manufacturing line is provided that is cost effective to implement. Yet a further advantage of the present invention is that a system, method and machine is provided that improves the processing speed of the associated manufacturing lines. Still yet a further advantage of the present invention is that a system, method and machine is provided with improved automation capability.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is an elevational view of a form, fill, seal machine according to the present invention.

FIG. 2a is an elevational view of a flexible pouch prepared using the machine of FIG. 1, according to the present invention.

FIG. 2b is an elevational view of a flexible pouch with a spout fitment prepared using the machine of FIG. 1, according to the present invention.

FIG. 3 is an elevational view of a tray for a product, according to the present invention.

FIG. 4 is a flowchart illustrating a method of forming, filling and sealing a container, according to the present invention.

FIG. 5 is a perspective view illustrating a box for transferring the flexible pouch to the machine of FIG. 1, according to the present invention.

FIG. 6 is a perspective view of an unloading device for use with the machine of FIG. 1, according to the present invention.

FIG. 7 is another embodiment of an unloading device for use with the machine FIG. 1, according to the present invention.

FIG. 8 is a diagrammatic view of an unload station for use with the machine of FIG. 1, according to the present invention.

FIG. 9 is another embodiment of an unload station for the machine of FIG. 1, according to the present invention.

FIG. 10 is a diagrammatic view of another fill-seal machine, according to the present invention.

FIG. 11 is a partial side view of the robotic transfer device, according to the present invention.

### DETAILED DESCRIPTION OF THE PREFERRED EMBODIMENTS

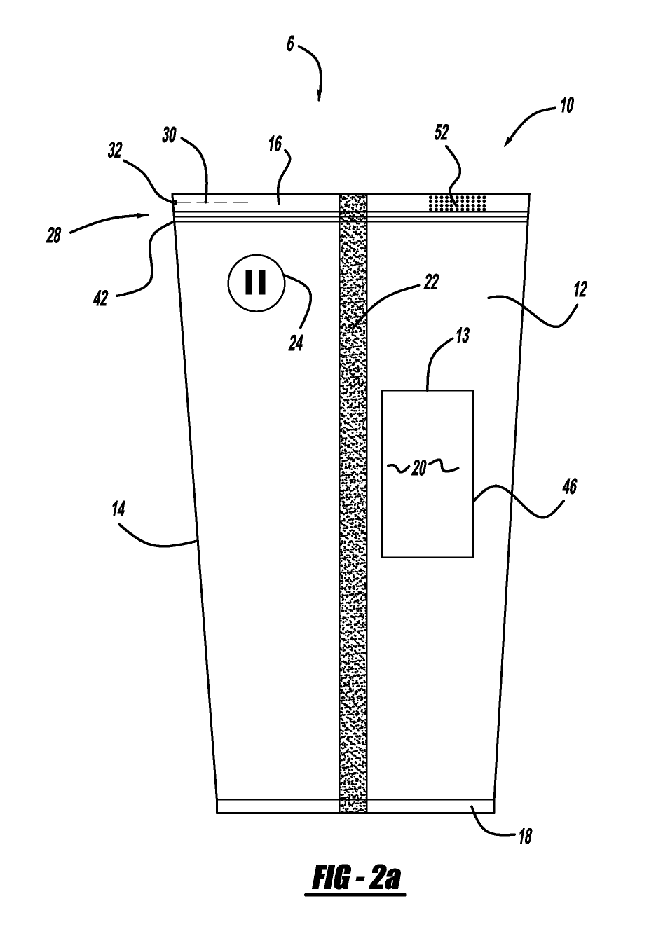

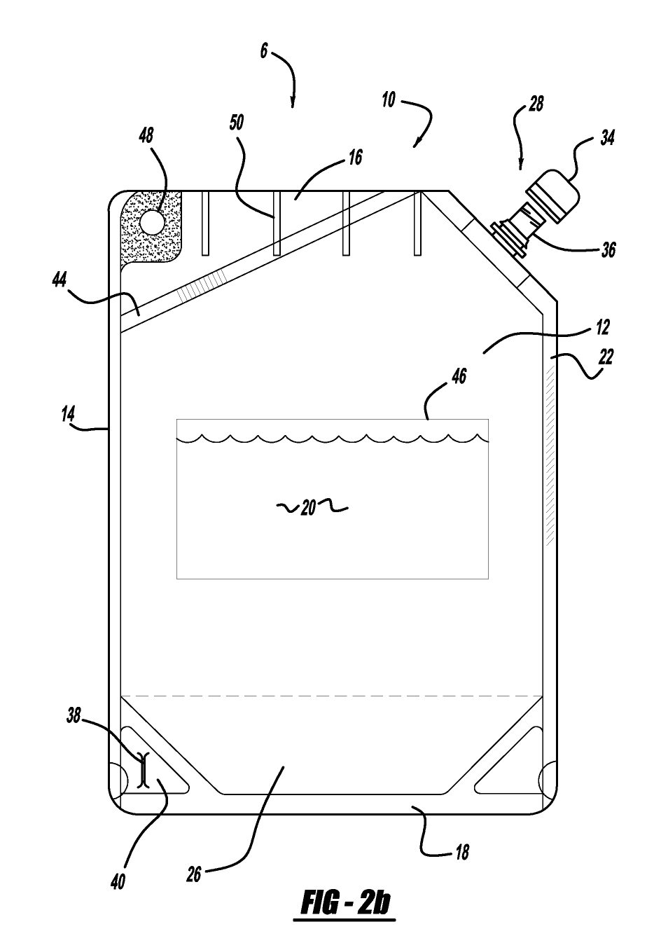

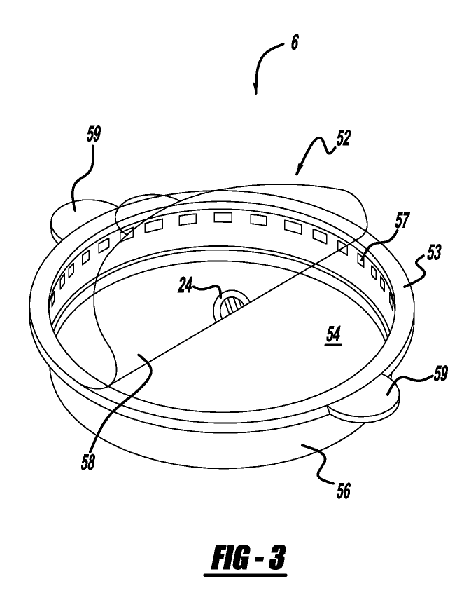

Automated machines are used in conjunction with the processing of a multitude of products. A common feature of such automated machines is the unloading and loading of an object, and the potential type, form, size and usage of the object is unlimited. For example, the object may be a product, and the machine packages the product. In another example, the object is a package 6 for a product, such as a flexible pouch, tray, or the like. The packaged product may be a food item or a non-food item, and may have a form that is solid, liquid, granular or a combination thereof. Referring to FIGS. 2a, 2b and 3, examples of a package 6 for a product, such as a flexible pouch 10 or tray 52, is illustrated.

With respect to a flexible pouch, the filled pouch 10 may assume various shapes, such as cylindrical, cube, conical, spherical, or the like. The type of product and intended usage of the pouch generally influences the shape. The pouch 10 may include one or more discrete compartments for containing the product 20. An example of such a pouch 10 is disclosed in commonly assigned U.S. patent application Ser. No. 11/367,613, which is incorporated herein by reference.

The flexible pouch 10 is preferably formed from a roll of flexible, preprinted laminate material. The choice of laminate material is nonlimiting, and is influenced by factors such as the product contained in the pouch 10, the shape of the pouch or the anticipated use of the pouch. The pouch 10 itself is defined by a panel, which may be formed using one or more sheets of material. The pouch 10 includes a front wall 12 and a back wall 14, and the edges of the panel are joined along a seam 22. With one sheet of material, the panel is manipulated so that its edges are joined together to form one seam. In another example of a pouch formed from two sheets of material, the pouch may be formed from two facing panels of material that are joined together along corresponding edges. These examples are merely illustrative of pouch shapes, and other pouch shapes may be utilized.

Further, the pouch generally defines an upper edge 16, an opposed lower edge 18, and at least one side edge extending therebetween the upper and lower edges 16, 18. Any of the edges of the pouch may be shaped, such as linear or curvilinear or the like. For example, the upper edge may include an elongated spout or neck portion. The edges of the pouch 10 may be sealed using heat or ultrasonics or by a combination of heat and ultrasonics. The pouch sealed edges form a seam 22. The seam 22 may be a fin-style seam, or a flat seam or the like.

The pouch 10 may include a feature such as a sidewall 26, which may be integrally formed in the panel as a gusset or a separate piece of material as an insert. The sidewall 26 may be located between any of the edges, such as the side edges of the panel, between the lower edges, between the upper edges, or a combination thereof. The sidewall 26 may have a shape.

The pouch includes an opening means 28 for accessing the contents or dispensing the contents from at least one compartment of the pouch 10. Various types of opening means 28 are known in the art for this purpose. It should be appreciated that the opening means 28 may be incorporated into the pouch 10 prior to filling the pouch 10. In addition, the pouch 10 may be filled through an open edge of the pouch or through a fitment. One example of an opening means is a tear-off portion 30 having an integral tear notch 32 and tear line, for removing a designated portion of the pouch to access the product contained therein. The tear-off portion 30 could be utilized in conjunction with another opening means, such as a zipper 42. The zipper opening means is a resealable zipper 42 that provides a hermetic seal through interlocking teeth, such as a zipper 42 that is sold under the name TopTite™. Another example of an opening means 28 is a weakened, straw-pierceable portion in the pouch for receiving a straw within at least one of the compartments. A further example of an opening means 28 is a pull tab covering an opening in the pouch. Still a further example of an opening means 28 is a fitment, such as a removable and replaceable cap 34 secured to a spout 36. The spout fitment 36 may be mounted between edges of the pouch, or in a portion of a wall.

It should be appreciated that the flexible pouch 10 may advantageously include other features that are known in the art. For example, the pouch may include a tracking device 38 integrally located on the pouch 10 that includes electronic tracking information relevant to the pouch 10, as described in commonly assigned U.S. patent application Ser. No. 11/686,666, which is incorporated by reference. The tracking device 38 may be an electronic tag, such as a Radio Frequency Identification (RFID) transmitter.

The pouch 10 may include a feature such as an angled top seal 44 extending between a first side edge and a predetermined location on the upper edge 16 of the pouch, as disclosed in commonly assigned U.S. patent application Ser. No. 11/683,133 which is incorporated herein by reference. Another example of a feature is a hanging aperture 48 located within an edge, such as an upper, lower or side edge. Another example of a feature is an insulating seal, which includes two seals separated by an airspace that creates a pocket of air that serves as an insulator. The pouch may include a feature such as a guide pocket formed in a wall 14, 16 of the pouch 10 prior to filling and sealing, to facilitate the separation of the front and back walls 14, 16 prior to the filling of the pouch 10, as disclosed in commonly assigned U.S. patent application Ser. No. 10/310,221. In a further example, the pouch may contain a rib 50 that adds strength or support or form to the body of the pouch. The rib 50 may be thermoformed. In still another example, the pouch may include a frangible seal, as disclosed in commonly assigned U.S. patent application Ser. No. 11/367,613 which is incorporated herein by reference.

The pouch may include a feature such as an integral vent means 24 that functionally exhausts a gas from the pouch. An example of a valve is disclosed in commonly assigned U.S. patent application Ser. Nos. 10/228,430 and 10/967,547 and PCT Patent Application No. PCT/US2004/34361 which is incorporated herein by reference.

The pouch may include a feature such as an ergonomic shape. An example of an ergonomically shaped pouch for a carbonated beverage is disclosed in commonly assigned U.S. patent application Ser. No. 11/454,241 which is incorporated herein by reference. The flexible pouch 10 may include a feature such as an outer layer or sleeve (not shown) covering the outer surface of the pouch. It is contemplated that the filled pouch 10 may undergo a secondary process. For example, the filled pouch may be refrigerated, frozen or otherwise modified for an extended shelf life. Alternatively, the filled pouch may be pasteurized for increased shelf life. Examples of pasteurized food products include dairy products such as milk, or meat products such as chicken or the like.

The above-described features are merely illustrative of features and the flexible pouch 10 may incorporate any of the above-described features or any other feature, in any combination. In addition, the finished pouch may assume various shapes, such as cylindrical, cubical, spherical, conical, and hourglass or the like, as influenced by the type of product and intended usage of the pouch. It should further be appreciated that the designated upper edge and lower edge is merely for reference purposes.

After the pouch 10 is formed, the pouch 10 is available for filling, such as through an opening formed between open edges of the panels. After filling, the open edges of the pouch are sealed using a conventional method, such as heat sealing, or ultrasonic sealing or a combination thereof. The closing seal may be a single seal, or a wide double seal. The seal may be a carbo seal, as disclose in commonly assigned U.S. patent application Ser. No. 10/533,615, which is incorporated herein by reference. The sealed pouch is then available for shipping or additional processing.

Referring to FIG. 3, a sealable tray 52 is illustrated. An example of a sealable tray 52 is described in commonly assigned U.S. patent application Ser. No. 11/288,430, which is incorporated herein by reference. The sealable tray 52 includes a lower portion that includes base wall, and a sidewall 56 extending perpendicular to an edge of the base wall to form the tray 52. The sealable tray 52 also includes and a removable upper portion 58, such as a heat sealable/peelable film cover 58. The film cover 58 may include a vent valve device 24, as previously described. The tray may include one or more compartments. The tray 52 may be produced from various materials, such as foam or a plastic such as cast polypropylene, or the like. The tray 52 may have various shapes, such as oval, rectangular, square, circular or the like. Ribs 57 may be formed in one of the walls, such as the sidewall 56, to provide strength. A handle 59 may be disposed at each end of the tray in order to facilitate moving of the tray 52.

The cover 58 may be formed using a film laminate. An example of a material includes a polyester layer, a polypropylene layer, and an adhesive layer, such as that available from WIPF of Volketswll, Switzerland. The product is filled into the tray 52, the cover 58 is placed over the tray compartment, and sealed to the tray. For example, the film may be heated to activate the adhesive layer and seal the cover 58 to an edge 53 of the tray 52. The cover 58 may be removed from the tray 52 to access the product contained therein.

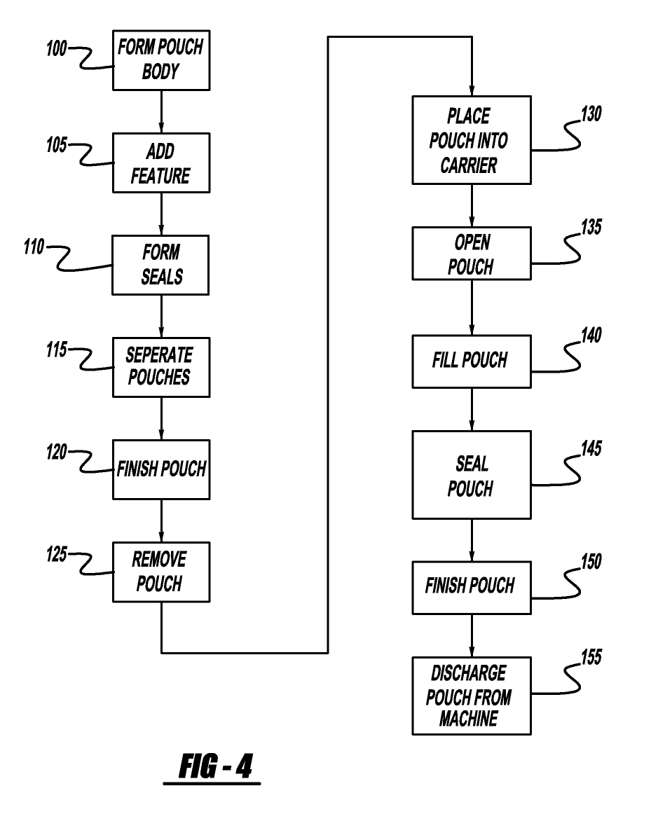

Referring to FIG. 4, a method for forming a package 6 is described. The method may be implemented on various styles and combinations of machines, including a form machine, a fill-seal machine, or a form-fill-seal machine. The method is described with respect to a flexible pouch, however similar steps can be utilized to form a tray 52. An example of a pouch forming machine is the Nishibe SMB500, SMB600 or SMB700. Another example is the Laudenberg form-fill-seal machine, FBM 10, 54, 20, 22.

The method begins in block 100 and includes the step of forming the body of the pouch 10 from a panel of material. The material is aligned and manipulated to represent the pouch body. Various techniques may be utilized in forming the body portion of the pouch, depending on the predetermined shape of the pouch. The methodology advances to block 105 and a feature may be added to the pouch, such as a sidewall or gusset 26 inserted between the walls of the pouch. In another example, the gusset 26, is a fold or pleat is formed in the panel using a folding operation to fold the panel. A features such as a tracking device 38 may be advantageously located within an airspace 40 created by an aperture in the gusset. Alternatively, the RFID transmitter may be secured on a surface of the wall in a predetermined position, so that it is located in an air pocket created during a later step. In another example, a shaping means, such as an insert may be positioned between the walls of the pouch. Still another example of a feature is a vent valve 24 inserted into one of the panels. In addition, an opening means 28, such as a fitment, may be applied to the panels.

The methodology advances to block 110 and includes the step of applying a seal to the pouch in a sealing operation. The seal can be a permanent seal, a temporary seal, a rib, or a frangible seal. Various types of seals are available, such as a single seal, a double seal, or an insulating seal, or the like. Various sealing techniques are known in the art to form each seal, and a combination of sealing techniques may be utilized. The seals may be a heat weld formed by applying heat and compression, or an ultrasonic seal formed using vibrational energy, or a combination of heat and ultrasonic seals. It should be appreciated that a previous seal may be absorbed during the sealing process. For example, the side edges and lower edges of the pouch 10 may be sealed, leaving the upper edges open, or all of the edges may be sealed. Other combinations are contemplated, depending on the type of fitment, product and filling technique. The side seal may be an overlap seal, whereby the side seal extends along the side edge of the panel and a predetermined distance along the upper edge. An angled top seal 44 may also be applied at this time. Advantageously, the seals may be shaped.

The methodology advances to block 115 and the individual pouches 10 formed in the roll width of material are separated from each other in a cutting operation. The methodology advances to block 120 and the pouch 10 may be further finished. For example, an edge may be trimmed so that the pouch 10 may acquire a predetermined shape, or the pouch corners may be shaped to have a radius, or the like. A hanging aperture 48, if present, may be formed at this time. The trimming operation may be performed using a cutter or a die cut or the like. In another example of a finishing operation, a crease or guide pocket may be formed in a top portion of each wall 12, 14 in a creasing operation, in order to facilitate opening and filling of the pouch. In still another example of a finishing operation, the sleeve is applied over the individual pouch and shrunk to fit using an application of heat to the pouch 10. In a further example of a finishing operation, a rib 50 may be added to the pouch 10. The rib may be thermoformed, and may provide the pouch 10 with shape or structure.

The methodology advances to block 125 and the formed pouch 10 is removed from the form line, placed in a storage device, and is ready for filling and sealing on a fill-seal line. It should be appreciated that the fill-seal line may be integral with the pouch forming machine, or may be a separate machine. Removal of the pouch 10 is accomplished using a transfer means, such as an individual, or a robotic transfer device, or the like. An example of a transfer device is disclosed in commonly assigned U.S. patent application Ser. No. 11/829,401, which is incorporated herein by reference, may be utilized. Another example of a transfer device is described herein.

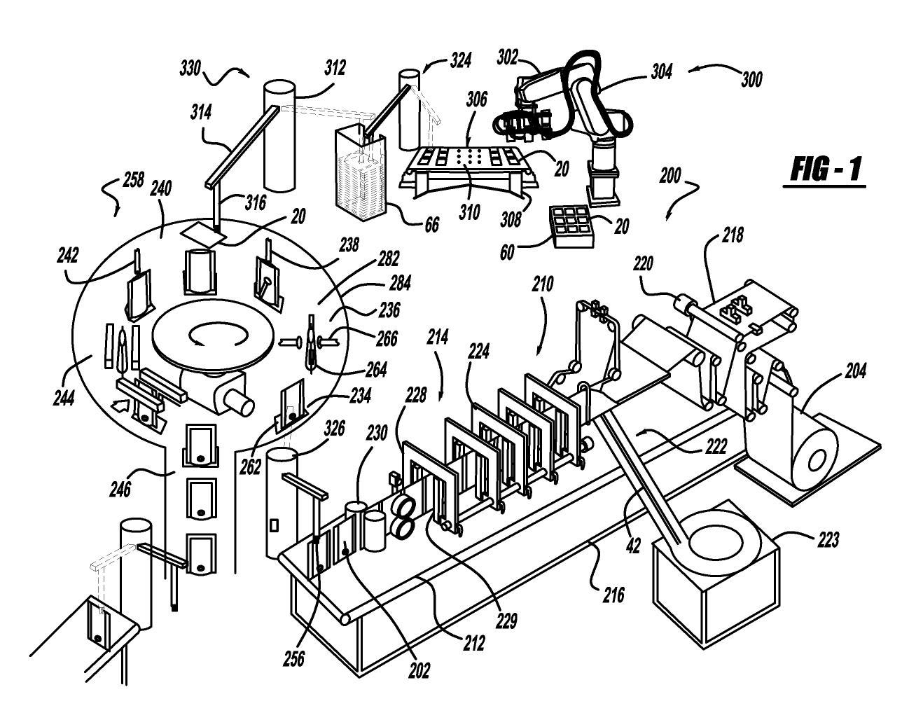

Referring back to FIGS. 1 and 10, the objects, such as the unfilled pouch, or tray or a product 20 are stored within a storage device 60, such as a magazine 66 or a box 62, or object holder 72 or the like. The pouches 10 may be arranged in the storage device 60 in a predetermined manner. For example, the pouches may be arranged in an alternating manner in order to maximize the number of pouches that the container can hold. In another example shown in FIG. 10, the objects 8 can be arranged in an array on a divided tray, and the trays are stacked in the storage device 60. The tray may include compartments for separating the objects 8. It is contemplated that the use of a storage device 60 to transfer a quantity of pouches 10 between the form and fill line operations will increase the flexibility of the machine.

Referring to FIG. 5, another example of a storage device, such as a box 62, is illustrated. The box 62 can be utilized to store objects 8 such as the pouch 10 or tray 52, or the product 20 to be sealed within the pouch 10 or tray 52. The box 62 is formed from a plurality of interconnected walls 63. One or more of the walls 63 may include a die cut panel 64 to facilitate access to the contents of the box 62. The die cut panel 64 is removable from the box 60, in order to allow access to the contents therein. In this example, the die cut panel 64 is located in a front wall 63, but it could be any of the walls. The box 62 can be placed on the machine either before the panel 64 is removed from the box 62, or after the die cut panel 64 is removed.

Referring to FIG. 1, still another example of a storage device, such as a magazine 66, is illustrated. The magazine includes a plurality of walls 68 that cooperatively form a compartment. The shape of the walls is selected to correspond with the shape of the object contained therein. The objects 8 are arranged adjacent to each other in the magazine compartment. The magazine 66 may include an intermediate wall 68a that divides the compartment 70 into sections, and a predetermined number of objects are stored in each section.

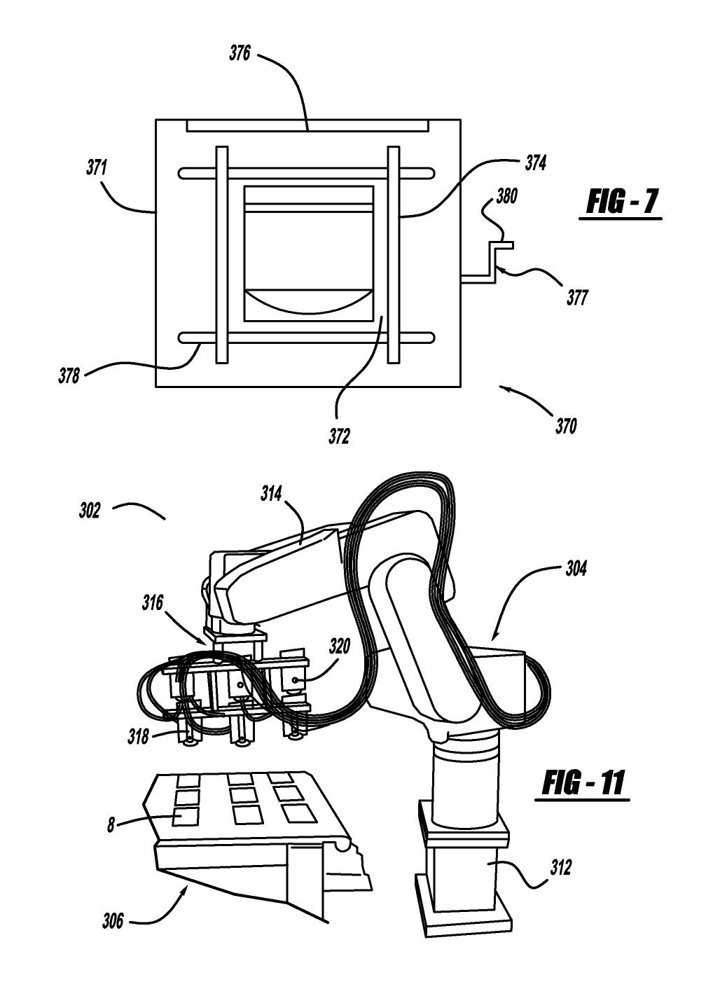

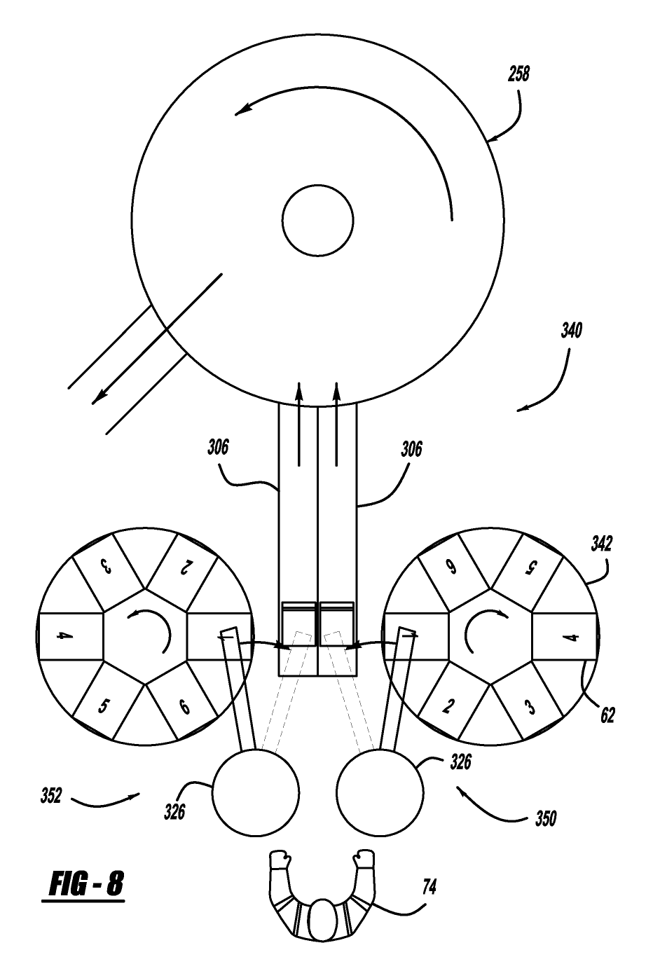

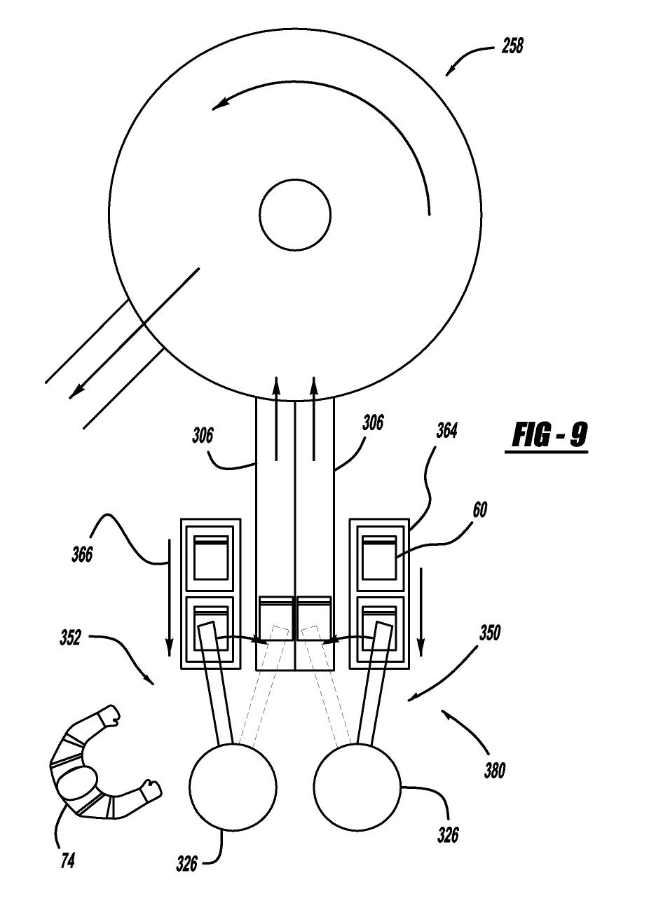

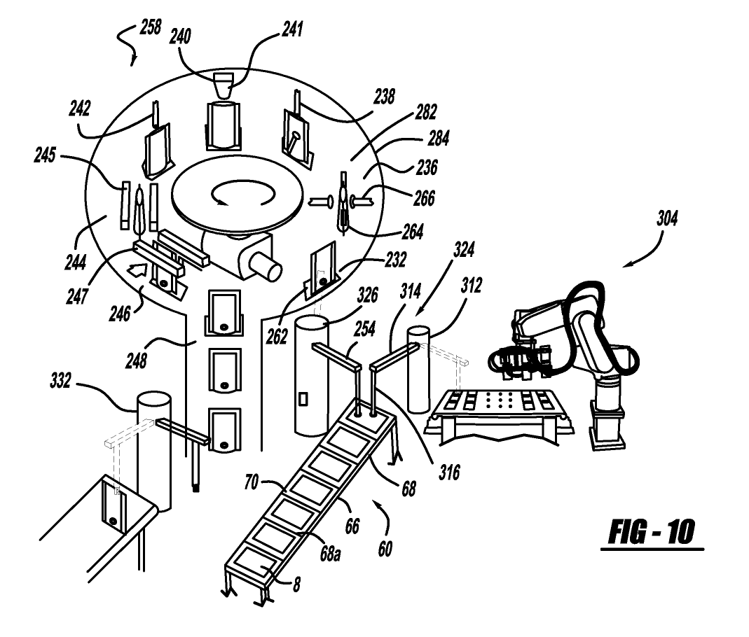

Referring to FIGS. 1 and 6-11, a system 300 for continuous unload/load of an object is illustrated. The system is implemented using one or more machines, depending on the product and manufacturing process. The system includes an unloading station 302. The unloading station 302 includes a first robotic transfer device 304 that picks up the object 8 and places it on an unload end of an in-feed device 306. The object 8 can be directly unloaded from the storage device 60 or the form line. The in-feed device 306 includes a first frame 308, and a transport device 310 disposed thereon, such as a conveyor or the like for moving the objects between stations.

The storage device 60, as previously described, is positioned adjacent the in-feed device. It should be appreciated that type of storage device and location of the storage device 60 with respect to the in-feed device 306 is selected to facilitate the automated process. In addition, a plurality of storage devices 60 may be located within the unloading station 302, to further expedite the unloading of objects 8.

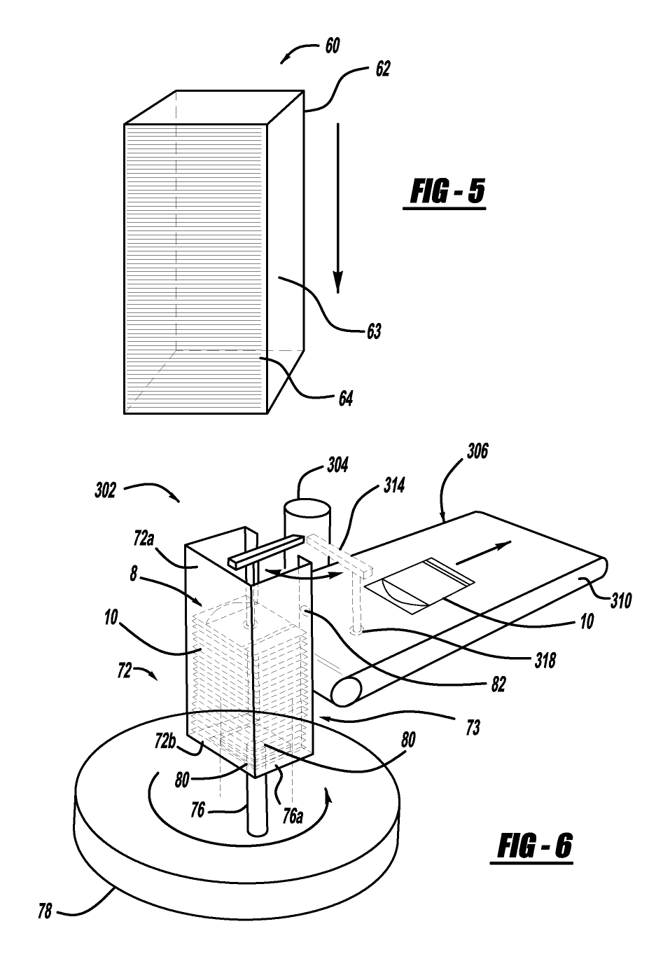

The unloading station may include an object holder 72, as illustrated in FIG. 6 that temporarily hold the objects and automatically maintains a level stack of objects within the box. The object holder 72 includes a rotatable base 78 and a pusher member 76 extending perpendicular to the base. In this example, the pusher member 76 is cylindrically shaped. A free end of the pusher member 76 may include a radially extending plate 76a that supports the objects 8 contained therein. The object holder 72 includes a plurality of sidewalls 72a, and a base wall 72b, that cooperatively form a temporary receptacle 73 for the object. The objects 8 are placed within the temporary receptacle 73, for example, the objects are removed from the storage device 60 and placed in the object holder 72. Various means may be utilized to place the objects 8 in the receptacle 73, such as an operator 74 or a robotic transfer device or the like. A base wall 72b of the temporary receptacle 73 includes an aperture 80 for receiving the pusher member 76, and the pusher member 76 is longitudinally moveable through the receptacle 73. In this example, the temporary receptacle 73 is oriented vertically, so that as the base 78 rotates, the pusher member 76 moves in an upwardly direction to push the lowermost object 8 in an upwardly direction towards an output end of the receptacle 73. As a result, the objects 8 within the object holder 72 remain within a consistent reach of the robotic transfer device. The object holder 72 may include a level sensing means 82, such as an optical eye or the like, that can detect the level of the objects 8 within the temporary receptacle 73, to further control the movement of the pusher member 76 through the temporary receptacle 73. The object holder 72 includes a controller (not shown) operatively in communication with an actuator and the level sensing means 82, that uses the information from the level sensing means 82 to cause the base 78 to rotate, and extend the pusher member 76 through the temporary receptacle 73, to maintain a consistent level of objects 8 within the object holder 72.

Another example of an object holder that is adjustable is illustrated in FIG. 7. The adjustable object holder 370 includes walls that can be varied to accommodate various sized objects 8. The adjustable object holder 370 includes a frame 371, and a moveable plate 372 initially positioned at a lower end of frame 371 for receiving the objects 8. The adjustable object holder 370 includes a level sensing means, controller and actuator, as previously described, for sensing the level of objects 8 and moving the plate 372 in an upwardly direction to maintain a consistent level of objects. The adjustable object holder 370 includes a pair of moveable guide walls 374 operatively supported by the frame 371 and positioned opposite each other. In this example, each guide wall 374 is a generally rectangular planer member. The guide walls 374 are spaced a predetermined distance apart using an adjustment means 377. In this example, the adjustment means includes a pair of guide adjustment slots 378 located in the frame 371. The guide adjustment slots 371 extend perpendicular to each of the guide walls 374, are parallel to each other, and spaced a predetermined distance apart. The guide walls are operatively supported within the guide adjustment slot 378. In this example, the adjustment means 377 includes a handle 380 operatively connected to each of the guide walls using a connecting means such as a link or the like. Rotation of the handle 380 moves the guide walls 374 within the guide slot 378 in an inwardly or outwardly direction. The adjustable object holder 370 may include additional guide walls, such as the stop guide 376, to further align the objects between the adjustable guide walls 378. The stop guide wall 376 may prevent the objects from falling off of the loading plate 372. In operation, the guide walls 374 are adjusted within the guide slots 378 to accommodate the shape of the object, such as pouches 10. A handle 380 may be actuated to adjust the position of the guide wall 374 within the slot 378, to ensure a proper enclosure of the objects 8. The objects 8 are placed onto the loading plate 372 between the guide wall 374 and stop guide wall 378. The adjustable object holder 370 with the pouches 10 thereon can then be placed onto a table 342.

Referring back to the system 300, a first robotic transfer device 304 is provided. The robotic transfer device 304 incorporates a base portion 312 and a moveable arm 314, whereby a proximate end of the arm is operatively attached to the base portion. The robotic transfer device 304 includes a controller that operatively controls the movement of the robot. A distal end of the arm 314 includes a gripping member 316 for picking up the object. The base 312 may be moveable, in order to facilitate actuation of the arm 314 in a predetermined manner. Once an object 8 has been attached to the gripping member 316, movement of the arm allows for the predetermined placement of object, such as onto an in-feed conveyor 306, or into a container such as a pouch 10 or tray 52 or into a storage device 60 or the like. Various types of gripping members 316 are available, and depend on the object to be picked up, such as a vacuum assisted suction cup, a mechanical gripper, an adhesive or combinations thereof or the like.

In this example, the gripping member 316 includes a vacuum operated suction member 318 that picks up the object from the object holder 72 or storage device 60 and places the object on the in-feed line conveyor. In this example the suction member 318 is a suction cup. The gripping member 316 may utilize an alignment sensing device 320 that determines the location of the object 8 within the storage device 60, and precisely picks up the object 8. For example, the alignment sensing device is an optical sensor that senses a predetermined locating indicia 13 on the object 8, and the suction member 318 is operatively positioned or aligned with respect to the predetermined locating indicia 13 on the object 8, so that each object 8 is picked up having the same orientation. It is contemplated that the suction member 318 may rotate or translate in order to adjust the orientation. The robotic transfer device 304 places the object on the in-feed device 306. The object 8 may be placed directly on the transport device, or in a holder 262 associated with the machine. It should be appreciated that a plurality of objects may be simultaneously picked up by a plurality of corresponding gripping members 316. The plurality of gripping members 316 may be arranged in a manner corresponding to the placement of the objects 8 in the storage device 60, such as a 4 by 6 array.

Referring back to the system 300, the in-feed device 306 transports the object 8 from the unload end to a load or output end of the in-feed device 306, and the object 8 is loaded off the in-feed device 306, in a manner to be described. The object 8 may be loaded into a holder 262, onto a transport device for another machine, or the like. For example, the load end of the in-feed device may adjoin a fill-seal line 258, and the object 8 moves directly to the fill-seal line, without intervention. In another example, an operator 74 loads the object 8 into another storage device 60, or object holder 72 or onto another manufacturing line, such as the fill-seal line 258. In still another example, a second robotic transfer device shown at 324 positioned at the load end of the in-feed device loads the object 8 into another storage device 60, or object holder 72 or onto another manufacturing line, such as the fill-seal line. The second robotic transfer device 324 is similar to the first robotic transfer device 304, in that it includes a base 312, an arm 314, and a gripping member 316 on a distal end of the arm 314. As shown in FIG. 10, the gripping member 316 of the second robotic transfer device 324 picks up the object 8 and places the object into a compartment of a magazine. As previously described, the gripping member 316 may incorporate an alignment sensing device 320, for accurately sensing a position of the object to uniformly pick up the object and place the object 8 in the magazine 66.

Referring back to the system 300, a third robotic transfer device, as shown at 326, may be positioned between the output end of a form line to be described, and the fill-seal line. The third robotic transfer device 326 is similar to the previously described robotic transfer devices, and includes a base 312, an arm 314, and a gripping member 316 on the end of the arm 314. In this example, the gripping member 316 includes a gripper 328 for grasping the pouch 10, removing the pouch or tray 10 from the form line, and placing the pouch or tray on the fill seal line.

The stations of the fill seal line 258 of the system 300 may be arranged in various configurations, such as a linear manner, or a circular manner. An example of a circular transport device 282 is a rotational transport table. The linearly arranged stations may be further oriented transversely or vertically. The fill-seal stations may be associated with a second frame and second transport device 282. In this example, a pouch carrier 262 moves between the fill-seal stations. Various types of pouch carriers 262 are available, such as a holder 262 or a gripper or the like. An example of a holder is a cup-shaped member, as disclosed in commonly assigned U.S. patent application Ser. No. 10/336,601, which is incorporated herein by reference. Another example is disclosed in commonly assigned U.S. patent application Ser. No. 11/829,401, which is incorporated herein by reference. In this example, in addition to a holder 262, a pair of opposed side edge grippers 264 each hold a corresponding side edge of the pouch. The side edge grippers 264 may be operatively connected to an actuating device for displacing the side edge gripper in the manner described to open the pouch. The holder 262 is operatively connected to the transport device 282, as previously described, for moving the pouch carrier between stations.

The fill-seal line 258 includes a pouch or tray unload station 232. The unload station 232 includes a transport holder 262, such as the gripper previously described. The unload station 232 may contain a plurality of transport holders 262, to simultaneously transfer a plurality of objects through the various stations of the fill-seal line 258. In this example, the third robotic transfer device 326 places the tray or pouch into the transport holder 262. It should be appreciated that the line speed between the unloading station 232 and the other fill-seal stations may be coordinated to input the pouches at a predetermined rate. Further, for a form-fill-seal machine, the line speed between the form stations 210 and the fill-seal stations 258 may similarly be coordinated, to enhance the overall pouch production rate.

Another example of a pouch or tray unloading station is shown in FIG. 8 at 340. The unloading station 340 includes a turntable 342 that is capable of turning in a predetermined direction. In this example, a storage box 62 of packages 6, or object holder 72 is placed on the turntable 342. As shown in FIG. 8, rotation of the turntable 342 allows for the placement of a storage device 60 or object holder 72 to an appropriate location with respect to the robotic transfer device 326, in order to provide a continuous supply of objects 8 to the fill-seal line. After the robotic transfer device 326 has removed all the objects 8 from the storage device 60 or object holder 72 labeled number “1” in FIG. 8, the turntable 342 of the unload station rotates and places the box or object holder labeled “2” into the position just occupied by box 1. It should be appreciated that the robotic transfer device 326 can sense the orientation of the object in the storage device 60 or object holder 72, and pick up the object 8 and orient the object 8 so that each of the objects 8 is placed onto unload end of the in-feed device 306 with the same orientation, as previously described. In this manner, objects 8 may be placed onto the in-feed device 306 without interruption, and with minimal operator 74 assistance. Advantageously, the operator 74 periodically unloads the empty storage devices 60 and replaces them with full storage devices 60, such as once every 1 to 4 hours.

In another example of an unloading station shown in FIG. 9 at 380, the transport table 364 is arranged linearly. The storage device 60 is moved in a direction shown at 366. In this manner, less space is occupied when compared to a rotatable transport table.

As shown in FIGS. 8 and 9, the unloading station may include a plurality of in-feed device 306 and corresponding robotic transfer device 326 and storage devices 60. For example, a third robotic transfer device 326 provides objects to a corresponding in-feed device 306 as shown at 350, and another robotic transfer device 326 provides objects to another corresponding in-feed device as shown at 352. One robotic transfer device may be utilized in order to place the objects onto a plurality of in-feed devices 306. Advantageously, objects of various shapes and sizes can be delivered to the fill line 258 at a corresponding rate. For example, with multiple in-feed lines, and/or robotic transfer means, containers are supplied at a relatively high rate to the fill machine.

Returning back to the system 200, an opening station 236 is provided for opening the package 6. In an example of a flexible pouch 10, the upper edges of the pouch 10 are separated for filling. The pouch 10 can be opened in various ways. For example, grippers may be used to grip the panels of the pouch, and separate the panels. The panel gripper 266 includes a gripping member positioned on an end of an arm. The arm is attached to an actuating device for moving the panel gripper 266 in predetermined directions. The gripping member is a suction cup that relies on the creation of a vacuum in order to grip the pouch. Other types of gripping members may be used, such as fingers or the like. There may be two opposed panel grippers 266, and the pouch 10 is positioned between the opposed panel grippers 266, so that each panel gripper 266 is adjacent an outer surface of the front wall 12 and back wall 14 respectively. To open the pouch, the side edge grippers 264 are moved inwardly towards each other while the panel grippers 266 holding the outer surface of each panel are displaced in an outwardly direction perpendicular or to the orientation of the pouch.

The opening station 236 may includes a pouch opening device for fully opening the pouch, as described in commonly assigned U.S. patent Ser. No. 11/933,784, which is incorporated herein by reference. In this example, the pouch opening device includes at least one pair of pouch opening fingers. The pair of pouch opening fingers come together to grip the wall disposed therebetween, and the actuating mechanism operatively displaces each pair of pouch opening fingers in an opposite direction away from each other, i.e. an outward direction, to fully open the pouch by separating the walls of the pouch.

The pouch 10 may be more fully opened at a second station, as shown at 238. For example, a stream of heated air may be directed toward the upper edges of the pouch, or through the spout. In addition, a nozzle may be mechanically lowered into the opened pouch 10. The nozzle is secured to a gas supply means. For example, a stream of compressed gas downwardly into the pouch to further force the walls of the pouch 10 away from each other to further the pouch. An example of a gas is carbon dioxide or nitrogen. In addition, the opening station 238 may include a manifold, with a hood extending over the top of the edges of the pouch. The manifold has rows of apertures (not shown) formed above the upper edges of the walls of the pouch. The hood is placed over the pouch to assist in maintaining the air pressure in the pouch. The supply of pressurized gas is directed through the aperture to form a plurality of jets of pressurized gas or air. The jets are directed downwardly at the diamond-shaped openings formed at the upper edges to assist in overcoming the surface tension of the walls and assist in separation of the walls. A diving rod may then be used to make sure the pouch is fully opened. Steam or another type of sterilizer may be utilized to clean an inside wall of the opened pouch.

The fill-seal line includes a fill station 240 and the package, such as the pouch 10 or tray 52 is filled with the product 20. In an example, the product 20 is placed into the opened pouch 10 or tray 52 by the fourth robotic transfer device 330, as shown in FIG. 1. A fourth robotic transfer device 330 may pick up a product 20 from a storage device 60 or object holder 72, as previously described, and place the product directly into an opened pouch 10 or tray 52 at the fill station 240. The fourth robotic transfer device 330 is positioned adjacent the fill station. The configuration of the fourth robotic transfer device 330 is similar to those previously described, and includes a base 312, an arm 314, and a gripping member 316 on the end of the arm 314. The movements of the fourth robotic transfer device and other robotic transfer devices may be sequentially coordinated. For example, the third robotic transfer device 326 may load and fourth robotic transfer device 330 may unload the same storage device. As shown in the example of FIG. 1, a pouch 10, tray 52 or other type of package 6 is placed into a holder 262 at an unloading station 232, and the product 20 is placed into the package 6 at a fill station 238 on the fill seal line 258. In this example, the product 20 is directed into the opened pouch 10 at a predetermined angle, in order to facilitate placement.

In another example of a fill station shown in FIG. 10, a product 20 transferred using a feed line to the fill-seal line. One end of the feed line is in communication with the product 20 in a storage device, while the other end of the feed line is secured to a nozzle 241 that dispenses a predetermined amount of product 20 into the opened pouch 10. The product 20 may be dispensed directly through the opened edges of the pouch 10 or through the spout. The feed line is operatively controlled by an actuator that lowers the nozzle into the opened pouch 10, and dispenses the product into the opened pouch. The nozzle may be raised at a predetermined rate out of the pouch that corresponds to the rate of filling the pouch. The controlled delivery of product may reduce any overspray. Depending on the size of the package 6, there may be multiple fill nozzles or fill stations.

If carbonation is desired, and the product is naturally carbonated, such as beer or soda or the like, the pouch may be filled while immersed in a nitrogen atmosphere. If the product 20 is not naturally carbonated, it may be immersed in a carbonator to introduce carbon dioxide into the product. For example, carbon dioxide is introduced into cold water or juice to provide a carbonated beverage. The product 20 may contain a mixture of up to four volumes of carbon dioxide. It should be appreciated that the carbon dioxide may also mask any undesirable taste from ketones and other solvents released during the sealing process. The carbon dioxide also increases the pressure within the product so that the walls of the pouch 10 are rigid after the top is sealed. The product 20 is preferably filled at a temperature ranging from 29° F. to ambient temperature. The carbonation is also advantageous as a microbicide that can enhance the flavor or prevent mold or contamination.

The fill-seal line 258 may include a gas removal station for removing any oxygen from the package 6 as shown at 242. The gas removal station may include a hood that evacuates the oxygen, or a diving nozzle that delivers a gas, such as carbon dioxide or nitrogen, or liquid nitrogen or the like, into the package 6 to displace the oxygen.

The fill-seal line 258 includes a closing station 244 that closes the package, such as the pouch 10 or tray 52. In an example of a pouch, the filled pouch 10 may also return to a partially closed position due to the product contained therein. The grippers are moved in a direction opposite the pouch 10, to close the upper edge of the pouch 10 by increasing the tension in the walls of the pouch. In an example of a pouch 10 having a zipper fitment, the zipper is closed using a closing apparatus that engages the zipper, and a portion of the pouch outboard of the zipper may be sealed. In another example of a pouch 10 filled through the open edges of the pouch, the closed edges of the pouch 10 are sealed using a closing seal. The closing seal may be a thermal seal. For example, a moveable heat sealing member 245 is positioned over the upper edge of the pouch to seal the upper edges together through the application of heat or heat and pressure. As previously described, the heat sealing member may have a plasma coating. Another example of a closing seal for a product utilizes an ultrasonic sealing process that includes a first closing seal. The ultrasonic seal may include sound waves and is formed using a horn and anvil.

The fill-seal line 258 may include a second closing station 246 for applying a second closing seal. The second closing seal may be applied using a heat seal means 247 to form a second heat seal spaced apart a predetermined distance from the first closing seal. It should be appreciated that the second closing seal may be spaced slightly outboard of the first closing seal. The second heat-sealing station 246 is conventional and utilizes heat or a combination of heat and pressure to form the seal. The second closing seal may also be a cosmetic seal or another type of seal, such as ultrasonic, ultra pulse or the like. The first and second seals are applied for a carbonated product as disclosed in commonly assigned PCT Patent Application No. PCT/US03/34396, which is incorporated herein by reference.

If the pouch 10 is filled through the spout fitment 36, the pouch 10 is closed by securing a cap 34 to the spout 36 using a cap application device. The cap 34 may have a tamper-evident feature. In addition, the cap 34 may contain a tracking device 38.

In an example of a tray 52, the cover 58 is sealed to an edge 53 of the sidewall 56 of the tray 52. The cover 58 may be sealed using an application of heat to activate an adhesive layer of the cover 58.

The fill-seal line includes a discharge station 248 for finishing and removing the pouch from the machine. A feature, such as a hanging aperture 48, may be formed at this time using a cutting device, such as a punch. In another example of a finishing operation, the edges of the pouch 10 may be trimmed to achieve a desired shape using a cutting device.

The fill-seal line may include another transfer device, such as a fifth robotic transfer device 332, for removing the sealed packages 6, such as pouches 10 or trays 52 from the machine. The sealed packages 6 may be placed into a shipping box or moved to another device or machine for additional processing.

It should be appreciated that the fill-seal line may include other operations. For example, the filled container may be transferred to another transport device, or otherwise collected. Alternatively, other stations may include a straw pierceable opening station, an upstream oxygen purging station, downstream oxygen purging station, or the like. In another example, the filled container is transferred to a packaging line, which may be integral with the fill-seal machine or a separate line. Still another example of additional processing is the filled container may be transferred to a pasteurization station. Pasteurization enhances the shelf life of the product. The filled package 6 is inserted into an enclosed chamber. For example, a combination of steam and water is used to heat the filled container to a predetermined temperature for a predetermined period of time to pasteurize the product contained therein. The filled package 6 is then cooled. In an example of a flexible pouch, recirculated water surrounds the pouch cool the pouch. In certain instances, it may be desirable to apply steam to sterilize the package 10 and to wet the inner surface of the walls to facilitate handling.

It should be appreciated that the described system may incorporated on or more machines. For example, the form line can be a machine, and the fill-seal line another machine, and a form-fill-seal line on still another machine.

Referring back to FIG. 4, a method of unloading the object 8 from a storage device 60 or object holder 72 onto a fill-seal line using the system for unloading/loading of an object 300 is further described. The method is described with respect to a flexible pouch although the use of other types of packages 6 is contemplated.

The method begins in block 130 with the step of removing the package, such as a pouch or tray, from a storage device 60 or object holder 72, as previously described. A robotic transfer device may be utilized to unload each of the objects 8 from the storage container or object holder and place them on the in-feed line. The methodology advances to block 135 and includes the step of opening a container, such as a flexible pouch, in an opening operation. A container such as a tray may already be open. Various techniques are utilized to open the pouch. An example of an opening technique is disclosed in commonly assigned U.S. patent application Ser. No. 11/933,744, which is incorporated herein by reference.

In block 140, the pouch 10 or tray 52 is filled with the product 20 in a filling operation. For example, a fill tube is lowered into the pouch a predetermined distance and the product is dispensed into the opened pouch. The product 20 is preferably dispensed at a predetermined temperature, depending on the type of product. The fill tube may be raised out of the pouch at a predetermined rate as the product 20 is dispensed. For example, the fill tube may be removed just ahead of the filling product.

If the product 20 is naturally carbonated, such as a sparkling wine or the like, the pouch is preferably filled while immersed in a nitrogen or carbon dioxide atmosphere. If the product 20 is not naturally carbonated and carbonation is desirable, it is immersed in a carbonator to introduce carbon dioxide into the product. For example, carbon dioxide is introduced into cold water or juice to provide a carbonated beverage. The product 20 may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch are rigid after the top is sealed. The product 20 is preferably filled at a temperature ranging from 29° F. to ambient temperature. The filled pouch 10 may have the oxygen removed from the pouch 10. For example, the pouch 10 may be flushed with carbon dioxide. Any gas in the head space of the pouch is removed. For example, oxygen may be removed by applying a vacuum.

In another example, the product 20 is placed into the pouch 10 or tray 52 using a robotic transfer device, as previously described. The filled packages 6 may be moved to a station where any oxygen in the pouch 10 residing above the product is removed, if necessary. This can be done by providing a hood or diving nozzle where oxygen is either evacuated or replaced with carbon dioxide or nitrogen into the pouch to displace the oxygen. A diving nozzle is used to inject the gas. The methodology advances to block 145.

In block 145 the pouch 10 or tray 52 is sealed. Various techniques are available for sealing the pouch 10 or tray 52. The seal technique depends on factors such as the product contained in the pouch or tray, the container shape, type of opening means or how the pouch is filled. For a pouch, the closing seal may be an ultrasonic seal or an ultra pulse seal or a heat weld or the like.

In an example of a pouch 10 filled through the open edges with a carbonated product, or product having an alcoholic content, the open edges of the pouch are closed by applying a first closing seal. The first closing seal may be an ultrasonic seal, or an ultra pulse seal. An example of a closing seal for a pouch 10 containing a carbonated product is described in commonly owned PCT Patent Application No. PCT/US03/034396 which is incorporated herein by reference.

A second closing seal may be applied a predetermined distance apart from the first seal. The second seal may be a heat weld or a cosmetic seal or an ultrasonic seal or the like. For a carbonated product, the location of the second seal is selected so that some of the product is trapped between the first and second seals. This is advantageous since it eliminates the potential for gas in the head space, i.e. the region between the product and the heat seal. The second seal is spaced outboard of the first seal. Another advantage of the location of the second seal is that the overall length of the pouch may be reduced, resulting in less pouch material. In a further example, the first closing seal is a tack seal, and the second closing seal is a high pressure, high temperature seal. A cosmetic seal may be applied with respect to the first and second closing seals, or the second seal may be a cosmetic seal. In an example of an overlap seal, the closing seal extends a predetermined amount over the side seal along the upper edge.

In yet another example of a pouch 10 having a spout fitment 36, the cap 34 is applied the spout 36 to close the pouch 10. The cap 34 contains the product in the filled pouch, to prevent leakage of the product from the pouch 10. The cap 34 may be a tamper-evident cap for a carbonated product.

In an example of a tray 52, a cover film 58, as previously described is heat sealed to the tray 52. The cover film 58 may include an adhesive layer that is heat activated to secure the film cover 58 to the edge 53 of the sidewall 56 of the tray 52.

In block 150, the filled package 6 is finished in a finishing operation. For example, the edges of a pouch 10 may be trimmed to achieve a predetermined pouch shape. In addition, the filled package 6 may be cooled at a cooling station using a conventionally known cooling technique. Optionally, the sleeve may be placed over the filled package 6 and shrunk to fit over the package by applying heat. The sleeve layer forms an outer layer of the package 6. The methodology advances to block 155.

In block 155, the filled package 6 is discharged from the machine. For example, the filled packages are moved to a discharge station 232. A robotic transfer device or an operator may be used to remove the package 6 from the fill-seal line. At this point, the filled package 6 is available for distribution or additional processing. For example, a filled package 6 may be pasteurized in an integral retort chamber (not shown) that heats and then cools the filled container. A pouch may be tested, such as burst testing or the like prior to packaging for shipping. These additional processing steps may take place at a station on the form/fill/seal apparatus, or on another apparatus. In another example, an operator removes the filled package 6 from the fill-seal line and places the filled package 6 into a shipping carton. In a further example, the robotic transfer device 252 transfers the filled package 6 to shipping cartons.

It is contemplated that the order of implementing the steps may vary to facilitate the manufacturing process. In addition, a manufacturing station may perform one or a plurality of operations, to enhance the efficiency of the methodology and apparatus. It should be appreciated that the methodology may include other steps, such as an upstream oxygen purging station, a downstream oxygen purging station, or pasteurization or the like. It is also contemplated that the order of implementing the steps may vary to facilitate the manufacturing process.

Referring back to FIG. 1, a form line for carrying out the method described with respect to FIG. 4 for the pouch of FIGS. 2 and 3 is illustrated. Various styles of machines 200 are contemplated for forming a flexible pouch 10, such as a flat bed, turntable or the like. The machine 200 may include a form line 210 of pouch forming stations and/or a fill-seal line 258 of fill-seal stations. It should be appreciated that a particular manufacturing station may perform one or a plurality of operations, to enhance the efficiency of the methodology and apparatus. The stations may be arranged in a linear manner, rotary manner, or a combination thereof. An example of a machine is manufactured by Nishibe, such as the model number SBM500, SMB600 or SMB700. Another example is the PSG LEE.

The form line includes a base 216 that supports a transport device 212 for moving the material through the various stations. Various styles of transport devices are contemplated, and a particular machine may include more than one style. Examples of a transport device include a conveyor, rollers, a turret or the like. The initial station is a material feed station, and the roll of material 204 is mounted and unrolled along a horizontally oriented axis.

The machine 200 also includes an alignment station 218 that aligns the unrolling material 204. For example, at the alignment station 218, the material rolls past a sensing device, such as an optical reader, that identifies a predefined point on the material 204. This predefined point may be a registration mark on the material, or an edge of the material 204. The machine 200 utilizes the registration marks to automatically adjust the orientation of the unrolling material position along an axis. For example, rollers 220 are used to adjust the position of the unrolling material ±2 degrees relative to a vertically oriented center axis.

The machine may include a fitment application station 222 that applies an opening means 28, such as a fitment, to the unrolling material at a predetermined location on the material. The machine may include a feeder mechanism 223, which supplies the fitment 42 to the machine. In this example, a feeder mechanism 223 supplies the unrolling material roll with a pre-applied fitment at a 90 degree angle to the direction of material 204 flow. It should be appreciated that the fitment may be simultaneously applied across all lanes in the predetermined panel location. For example, in a 10 lane machine with 10 panels, arranged in a linear line of 10, 10 fitments are simultaneously sealed to the material. At a rate of 50 strokes per minute, 500 fitments per minute may be applied to the unrolling material.

The machine includes a cutting station 224 where the material is cut into a predetermined number of sections. For a pouch made from two panels of material, one of the sections is rotated 180 degrees, and the first and second sections of this example are positioned such that inner sides face one another. The sections are used to form the front panel and back panel of the pouch, respectively.

The machine may include a feature insertion station that adds a feature, as previously described, between the facing sheets of material. The facing sections are transferred along the conveyer to a sealing station.

The machine includes a sealing station 228 that applies a seal to the pouch 10. Various sealing techniques are known in the art, and depend on the application. The seal may be a heat weld formed by applying heat and compression, or an ultrasonic seal formed using vibrational energy, or a combination of heat and ultrasonic seals. In addition, a previous seal may be absorbed during the sealing process. An example of some applications includes sealing an edge of the pouch, securing a fitment to the pouch, forming a rib or another thermoformed feature.

The sealing station may include a seal bar 229 to apply the seal. In an example, there are two opposed seal bars, and the pouch fits between the seal bars. The seal bar may include a cavity surface that corresponds to a predetermined shape. The cavity may be for sealing a fitment, or creating an airspace or the like. The sealing station 228 may form the seams joining the edge of each panel to delineate each pouch. In this example, the side edges of each of the pouches along the width of material are heat-sealed. By precise alignment of the material sheets, the width of the side edge seam may be reduced, such as 4 mm, with a tolerance of ±1 mm.

The machine includes a cutting station 230 and the sealed panels are separated into individual pouches. For example, the pouch is separated along an edge seam. The pouch 10 may also be separated from the unrolling material along the upper edge and lower edge. The cut may be a double cut, so as to separate two pouches 10 at one time. It should be appreciated that the pouches 10 are fully formed, and are now ready for filling.

The machine includes a pouch removal station 256, and the pouch is placed into a container, such as a box or a magazine, for transfer to a fill-seal line. An operator or a robotic transfer device may be utilized at this station.

It should be appreciated that a similar form line and corresponding machine can be utilized to form the tray 52.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A system for continuous unloading and loading of an object with respect to an apparatus comprising:
an unloading station having an in-feed device, wherein the in-feed device includes a frame and a transport device disposed on the frame that moves an object between a unload end of the in-feed device and a load end of the in-feed device;
a robotic transfer device positioned at the unload end of the in-feed device, wherein the robotic transfer device includes a base portion, an arm attached to the base portion and a gripping member located on a distal end of the arm;
a storage device positioned adjacent the unload end of the in-feed device containing a plurality of objects arranged in a predetermined manner, wherein the robotic transfer device operatively unloads each of the objects from the storage device and places each of the objects on the unload end of the transport device, and each of the objects are transported to the load end of the in-feed device, for loading onto the apparatus.

2. The system of claim 1 further comprising a second robotic transfer means positioned at the loading end of the in-feed device, wherein the second robotic transfer device includes a base portion, an arm attached to the base portion and a gripping member located on a distal end of the arm, and the second robotic transfer device loads the object onto another storage device.

3. The system of claim 1 further comprising a second robotic transfer means positioned at the loading end of the in-feed device, wherein the second robotic transfer device includes a base portion, an arm attached to the base portion and a gripping member located on a distal end of the arm, and the second robotic transfer device loads the object into an automated fill-seal machine.

4. The system of claim 3 further comprising a third robotic transfer device positioned adjacent an unloading station for the fill-seal machine, wherein the third robotic transfer device includes a base portion, an arm attached to the base portion and a gripping member located on a distal end of the arm, and the third robotic transfer device unloads a package into a holder associated with the unloading station.

5. The system of claim 4 further comprising a fourth robotic transfer device places the object into a package at a fill station for the fill-seal machine, and the package is sealed wherein the fourth robotic transfer device includes a base portion, an arm attached to the base portion and a gripping member located on a distal end of the arm.

6. The system of claim 5 further comprising a fifth robotic transfer device positioned adjacent a discharge station for the fill-seal machine, wherein the fifth robotic transfer device includes a base portion, an arm attached to the base portion and a gripping member located on a distal end of the arm, and the fifth robotic transfer device loads a sealed package off the fill-seal machine.

7. The system of claim 2 wherein the second robotic transfer device loads the object into another storage device, and a robotic transfer device having a base portion, an arm attached to the base portion and a gripping member located on a distal end of the arm that is position between another storage device and the fill seal line, unloads the object from the another storage device and places the object on a fill-seal machine.

8. The system of claim 1 wherein the robotic transfer device includes a sensing means for sensing an orientation of the object with respect to an orientation of the gripping member using a locating indicia on the object, and operatively aligns the orientation of the gripping member with respect to the orientation of the object.

9. The system of claim 1 further comprising a unloading station having a plurality of storage devices positioned on a moveable table, and the table sequentially repositions each of the storage devices when the storage device is empty to provide the robotic transfer device access to the objects contained therein.

10. The system of claim 9 wherein the table is circular and the table rotates.

11. The system of claim 9 wherein the table is rectangular and the table translates linearly.

12. The system of claim 1, further comprising a object holder having:
a rotatable base,
a pusher member extending perpendicular to the base, having a free end with a radially extending plate for supporting the object,
a receptacle having a plurality of side walls and a base wall for receiving the object therein, wherein the base wall includes an aperture for receiving the pusher member; and
a level sensing means for sensing the level of the object within the receptacle and the pusher member extends longitudinally therethrough the receptacle by rotating the base to maintain a predetermined level for the object within the receptacle.

13. The system of claim 9 wherein the object holder is adjustable, further comprising:
a frame having a pair of opposed guide wall adjustment slots;
a moveable plate moveably positioned within the frame for supporting the object;
a pair of moveable, opposed, guide walls operatively supported within guide wall adjustment slots of the frame, wherein each guide wall is a generally rectangular member; and
an adjustment means operatively connected to the guide walls for adjusting a predetermined distance between the guide walls to correspond to a size of the object.

14. The system of claim 13 further comprising a stop guide wall extending transversely between the moveable guide walls.

15. An object holder for supplying an object to a machine comprising:
a rotatable base,
a pusher member extending perpendicular to the base, having a free end with a radially extending plate for supporting the object,
a receptacle having a plurality of side walls and a base wall for receiving the object therein, wherein the base wall includes an aperture for receiving the pusher member; and
a level sensing means for sensing the level of the object within the receptacle and the pusher member extends longitudinally therethrough the receptacle by rotating the base to maintain a predetermined level for the object within the receptacle.

16. An adjustable object holder for supplying an object to a machine comprising:
a frame having a pair of opposed guide wall adjustment slots;
a moveable plate moveably positioned within the frame for supporting the object;
a pair of moveable, opposed, guide walls operatively supported within guide wall adjustment slots of the frame, wherein each guide wall is a generally rectangular member; and
an adjustment means operatively connected to the guide walls for adjusting a predetermined distance between the guide walls to correspond to a size of the object.

17. A robotic transfer device for unloading an object from a box and placing the object on a in-feed line, comprising:
a base portion;
an arm attached to the base portion;
a gripping member located on a distal end of the arm;
a sensing means associated with the gripping member, for sensing an alignment of the gripping means with respect to an alignment of the object using a locating indicia and using the sensed alignment to realign the gripping means to correspond with the object alignment.

18. A method for continuous unloading and loading of an object onto an apparatus including the steps of:
providing an unloading station having an in-feed device, wherein the in-feed device includes a frame and a transport device disposed on the frame that moves the object between an unload end of the in-feed device and a load end of the in-feed device;
positioning a first robotic transfer device at the unload end of the in-feed device, wherein the robotic transfer device includes a base portion, an arm attached to the base portion and a gripping member located on a distal end of the arm;
positioning a storage device adjacent the unload end of the in-feed device for holding a plurality of objects arranged in a predetermined manner;
using the robotic transfer device to unload the objects from the storage device and place the objects on the transport device;
transporting each of the object to the load end of the in-feed device;
positioning a second robotic transfer device at the unload end of the in-feed device, wherein the second robotic transfer device includes a base portion, an arm attached to the base portion and a gripping member located on a distal end of the arm and the second robotic transfer device loads the object onto an apparatus for use in packaging of a product.

19. The method as set forth in claim 18, wherein the apparatus is another storage device, and the another storage device stores a plurality of objects for use by a fill-seal machine for packaging a product.

20. The method as set forth in claim 19 further comprising the step of using another robotic transfer device to unload the plurality of objects from the another storage device onto the fill-seal machine.
